(19) United States
(12) Patent Application Publication
(10) Pub. No.: US 2026/0220860 A1
(43) Pub. Date: Jul. 30, 2026

(54) ANIMATION DATA GENERATION METHOD, ANIMATION DATA PLAYBACK METHOD, AND DEVICE AND STORAGE MEDIUM

(71) Applicant: Beijing Zitiao Network Technology Co., Ltd., Beijing (CN)

(72) Inventors: Yang LI, Beijing (CN); Zhicheng WANG, Beijing (CN)

(21) Appl. No.: 19/144,431

(22) PCT Filed: Mar. 6, 2024
(86) PCT No.: PCT/CN2024/080362

§ 371 Date: Jun. 27, 2025

(30) Foreign Application Priority Data
Mar. 6, 2023 (CN) 202310233306.0

(51) Int. Cl. G06T 13/00; H04N 19/50

(52) U.S. Cl. CPC G06T 13/00; H04N 19/50

(57) ABSTRACT

Provided in the embodiments of the present disclosure are an animation data generation method, an animation data playback method, and a device and a storage medium. The animation data generation method comprises: acquiring an image set to be processed, wherein said image set at least comprises a first image frame and a second image frame, the first image frame is an animation starting frame of a target animation, and the second image frame is a next image frame adjacent to the first image frame; acquiring a frame difference picture according to the first image frame and the second image frame, wherein the frame difference picture represents different content of the second image frame than the first image frame; and according to the first image frame and the frame difference picture, generating animation data corresponding to the target animation.

### CROSS-REFERENCE TO RELATED APPLICATIONS

The present application a U.S. National Stage Application under 35 U.S.C. § 371 of International Patent Application No. PCT/CN2024/080362, filed on Mar. 6, 2024, which is based on and claims priority to CN application No. 202310233306.0, filed on Mar. 6, 2023, both of which are incorporated herein by reference in their entireties.

### TECHNICAL FIELD

Embodiments of the present disclosure relate to the field of image processing technologies and, in particular, to an animation data generation method, an animation data playback method, a device, and a storage medium.

### BACKGROUND

Animation, also known as dynamic effects and animated pictures, refers to images that can be displayed dynamically. Compared to static pictures that are statically presented, animations offer superior information expression effects and are widely applied in various types of web pages and applications.

In the related art, animation playback is usually implemented based on ordered playback of multiple frames of pictures. Therefore, before playing an animation, it is necessary to first create and generate animation data containing multiple frames of static pictures. The static pictures in the animation data are then played to achieve the effect of animation playback.

### SUMMARY

In a first aspect, an embodiment of the present disclosure provides an animation data generation method, including:
obtaining a set of images to be processed, where the set of images to be processed includes at least a first image frame and a second image frame, where the first image frame is an animation start frame of a target animation, and the second image frame is a subsequent image frame adjacent to the first image frame; obtaining a frame difference picture based on the first image frame and the second image frame, where the frame difference picture represents a differential content of the second image frame relative to the first image frame; and generating animation data corresponding to the target animation based on the first image frame and the frame difference picture.

In a second aspect, an embodiment of the present disclosure provides an animation data playback method, including:
obtaining animation data corresponding to a target animation, where the animation data is generated by the animation data generation method as described in the above first aspect and various possible designs of the first aspect; obtaining a first image frame and a second image frame based on the animation data, where the first image frame is an animation start frame of the target animation, and the second image frame is a subsequent image frame adjacent to the first image frame; and playing at least the first image frame and the second image frame in sequence.

In a third aspect, an embodiment of the present disclosure provides an animation data generation apparatus, including:
an obtaining module configured to obtain a set of images to be processed, where the set of images to be processed includes at least a first image frame and a second image frame, where the first image frame is an animation start frame of a target animation, and the second image frame is a subsequent image frame adjacent to the first image frame;
a processing module configured to obtain a frame difference picture based on the first image frame and the second image frame, where the frame difference picture represents a differential content of the second image frame relative to the first image frame; and
a generation module configured to generate animation data corresponding to the target animation based on the first image frame and the frame difference picture.

In a fourth aspect, an embodiment of the present disclosure provides an animation data playback apparatus, including:
an obtaining module configured to obtain animation data corresponding to a target animation, where the animation data is generated by the animation data generation method as described in the above first aspect and various possible designs of the first aspect;
a processing module configured to obtain a first image frame and a second image frame based on the animation data, where the first image frame is an animation start frame of the target animation, and the second image frame is a subsequent image frame adjacent to the first image frame; and
a playback module configured to play at least the first image frame and the second image frame in sequence.

In a fifth aspect, an embodiment of the present disclosure provides an electronic device, including:
a processor and a memory communicatively connected to the processor, where
the memory stores computer-executable instructions; and
the processor executes the computer-executable instructions stored in the memory to implement the animation data generation method as described in the above first aspect and various possible designs of the first aspect or the animation data playback method as described in the above second aspect and various possible designs of the second aspect.

In a sixth aspect, an embodiment of the present disclosure provides a computer-readable storage medium storing computer-executable instructions that, when executed by a processor, cause the animation data generation method as described in the above first aspect and various possible designs of the first aspect or the animation data playback method as described in the above second aspect and various possible designs of the second aspect to be implemented.

In a seventh aspect, an embodiment of the present disclosure provides a computer program product including a computer program that, when executed by a processor, causes the animation data generation method as described in the above first aspect and various possible designs of the first aspect or the animation data playback method as described in the above second aspect and various possible designs of the second aspect to be implemented.

In an eighth aspect, according to some embodiments of the present disclosure, there is provided a computer program, including instructions that, when executed by a processor, cause the processor to implement the animation data generation method of any embodiment of the present disclosure.

### BRIEF DESCRIPTION OF THE DRAWINGS

In order to describe the technical solutions in embodiments of the present disclosure or in the related art more clearly, the accompanying drawings for describing the embodiments or the related art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a diagram of an application scenario of an animation data generation method according to some embodiments of the present disclosure;

FIG. 2 is a schematic flowchart of an animation data generation method according to some embodiments of the present disclosure;

FIG. 3 is a flowchart of a specific implementation of Step S102 in the embodiment shown in FIG. 2;

FIG. 4 is a schematic diagram of a difference image block according to some embodiments of the present disclosure;

FIG. 5 is a flowchart of a specific implementation of Step S1023 in the embodiment shown in FIG. 3;

FIG. 6 is a schematic diagram of generating a frame difference picture according to some embodiments of the present disclosure;

FIG. 7 is a schematic flowchart of an animation data generation method according to some other embodiments of the present disclosure;

FIG. 8 is a schematic diagram of a process of determining a difference image block according to some embodiments of the present disclosure;

FIG. 9 is a flowchart of a specific implementation of Step S208 in the embodiment shown in FIG. 7;

FIG. 10 is a schematic diagram of a process of generating a first frame difference picture and a second frame difference picture according to some embodiments of the present disclosure;

FIG. 11 is a schematic flowchart of an animation data playback method according to some embodiments of the present disclosure;

FIG. 12 is a block diagram of a structure of an animation data generation apparatus according to some embodiments of the present disclosure;

FIG. 13 is a block diagram of a structure of an animation data playback apparatus according to some embodiments of the present disclosure;

FIG. 14 is a schematic diagram of a structure of an electronic device according to some embodiments of the present disclosure; and

FIG. 15 is a schematic diagram of a hardware structure of an electronic device according to some embodiments of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It should be noted that user information (including but not limited to device information, personal information, etc., of a user) and data (including but not limited to data for analysis, stored data, displayed data, etc.) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

An application scenario of the embodiments of the present disclosure is described below.

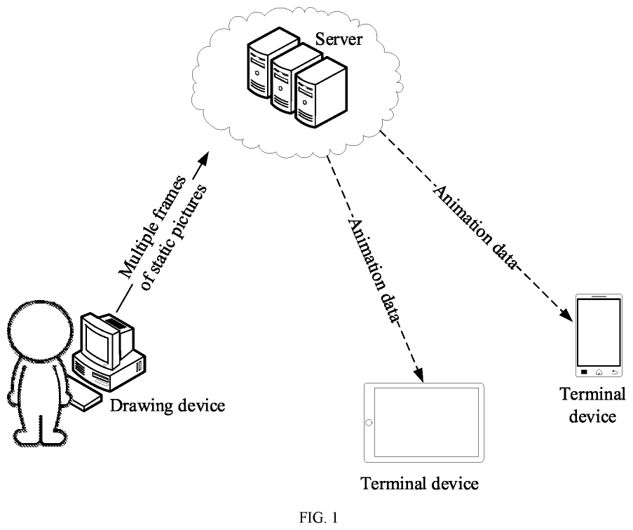

FIG. 1 is a diagram of an application scenario of an animation data generation method according to some embodiments of the present disclosure. The animation data generation method according to the embodiments of the present disclosure may be applied to application scenarios such as animation production and playback. In particular, the method according to the embodiments of the present disclosure may be applied to a terminal device, a server, or other electronic devices having similar functions. Referring to FIG. 1, in some embodiments, a server serves as an execution entity for the method according to the embodiments of the present disclosure. The server may communicate with a drawing device and a terminal device, respectively, where the drawing device is an electronic device operated by an animation production user for drawing and producing animations. The drawing device sends multiple frames of static pictures drawn by the user to the server. The server processes the multiple frames of static pictures using the animation data generation method according to this embodiment to generate animation data corresponding to a target animation. The above process is a process of generating animation data. Next, the terminal device obtains the animation data from the server, decodes the animation data locally to restores the multiple frames of static pictures sent by the drawing device, and plays the multiple frames of static pictures in sequence, thereby implementing playback of the target animation. The above process is the process of playback of animation data.

In the related art, in the process of generating animation data, multiple frames of static pictures are compressed to generate corresponding animation data. This compression process is primarily based on the compression of each frame of static picture, such as reducing the resolution of each frame of static picture, thereby reducing the data volume of each frame of static picture, and consequently achieving the objective of reducing the overall data volume of the animation data. However, the animation data generated still contains a large number of static pictures. Therefore, if a low compression ratio is used to ensure the display effects of the static pictures, it will result in a large volume of the animation data, which occupies additional storage and network resources. If a high compression ratio is used to ensure a small volume of the animation data, it will lead to issues such as excessively low resolution and definition of the restored static pictures, which affects the visual effects of the animation playback. An embodiment of the present disclosure provides an animation data generation method to address the above problems.

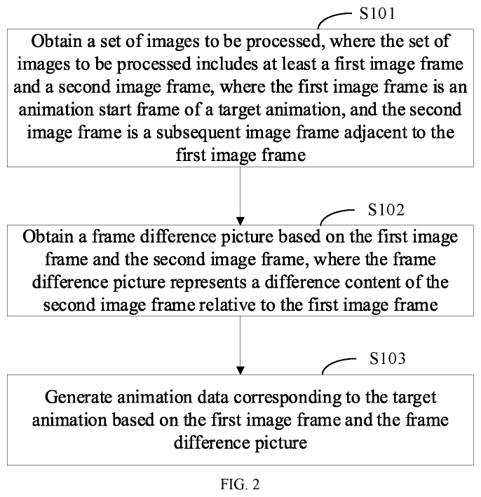

Referring to FIG. 2, FIG. 2 is a schematic flowchart of an animation data generation method according to an embodiment of the present disclosure. The method in this embodiment may be applied to an electronic device such as a server and a terminal device. The animation data generation method includes: steps S101 to S103.

Step S101: Obtain a set of images to be processed, where the set of images to be processed includes at least a first image frame and a second image frame, where the first image frame is an animation start frame of a target animation, and the second image frame is a subsequent image frame adjacent to the first image frame.

In some embodiments, with reference to the schematic diagram of the application scenario shown in FIG. 1, the server serves as the execution entity, and the server receives a set of static pictures, i.e., a set of images to be processed, sent by a first terminal device. The set of images to be processed at least includes two frames of images, namely, a first image frame and a second image frame. The first image frame is an animation start frame of the target animation, and the second image frame is a subsequent image frame adjacent to the animation start frame. Of course, in a possible implementation, other sequentially arranged image frames may also be included following the second image frame. By sequentially displaying a plurality of ordered image frames in the set of images to be processed, a playback process of the target animation can be achieved. The specific process will not be elaborated further. In some embodiments, the specific implementation of obtaining the set of images to be processed and loading the first image frame and the second image frame is provided.

Step S102: Obtain a frame difference picture based on the first image frame and the second image frame, where the frame difference picture represents a differential content of the second image frame relative to the first image frame.

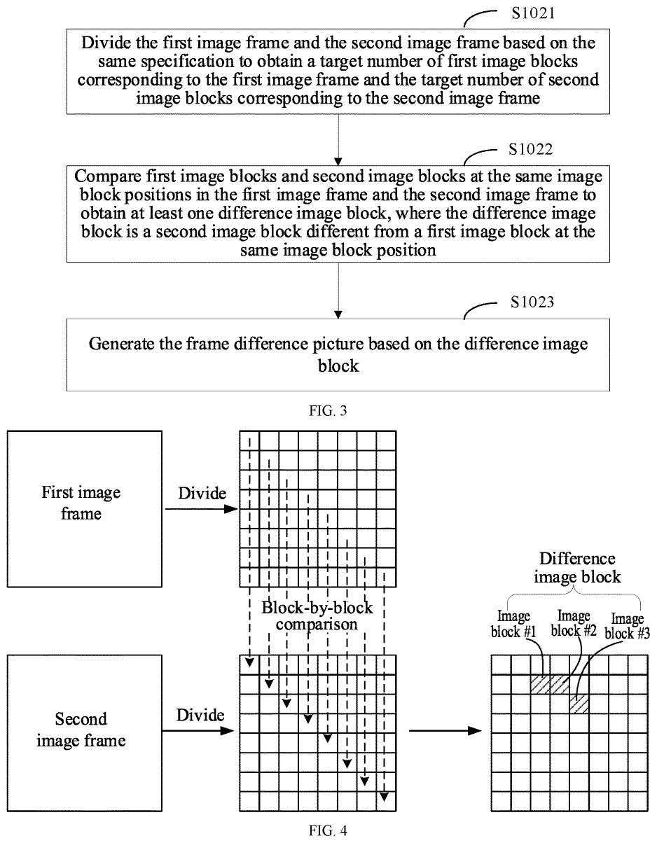

In some embodiments, after obtaining the first image frame and the second image frame in the set of images to be processed, the two are compared. Based on the result of the comparison, an image difference region between the two can be determined. The image difference region includes at least one pixel (corresponding region), namely, a pixel having different pixel values at the same position of the first image frame and the second image frame. In another possible implementation, after performing region division on the first image frame and the second image frame using the same rule, the image difference region refers to a set of regions having different pixel values with respect to the same regional position of the first image frame and the second image frame. In some embodiments, as shown in FIG. 3, a specific implementation of step S102 includes: steps S1021 to S1023.

Step S1021: Divide the first image frame and the second image frame based on the same specification to obtain a target number of first image blocks corresponding to the first image frame and the target number of second image blocks corresponding to the second image frame.

Step S1022: Compare first image blocks and second image blocks at the same image block positions in the first image frame and the second image frame to obtain at least one difference image block, where the difference image block is a second image block different from a first image block at the same image block position.

Step S1023: Generate the frame difference picture based on the difference image block.

In some embodiments, in general, the first image frame and the second image frame have the same dimensions. Therefore, by dividing the first image frame and the second image frame based on the same rule, the same target number of image blocks can be obtained, namely, the first image blocks corresponding to the first image frame and the second image blocks corresponding to the second image frame. Next, image blocks at each corresponding position are compared, and if the first and second image blocks are different at the image block position, the image blocks (for example, the second image block) corresponding to the image block position are difference image blocks. Conversely, if the first and second image blocks are the same at the image block position, the image blocks corresponding to the image block position are non-difference image blocks.

FIG. 4 is a schematic diagram of a difference image block according to an embodiment of the present disclosure. As shown in FIG. 4, after dividing the first image frame and the second image frame based on an 8×8 division rule, 64 first image blocks (8 rows and 8 columns) and 64 second image blocks (8 rows and 8 columns) are obtained, respectively. Next, after performing block-by-block comparison on image blocks at each corresponding position of the first image frame and the second image frame, three difference image blocks can be obtained, namely, image block #1, image block #2, and image block #3 in the second image frame.

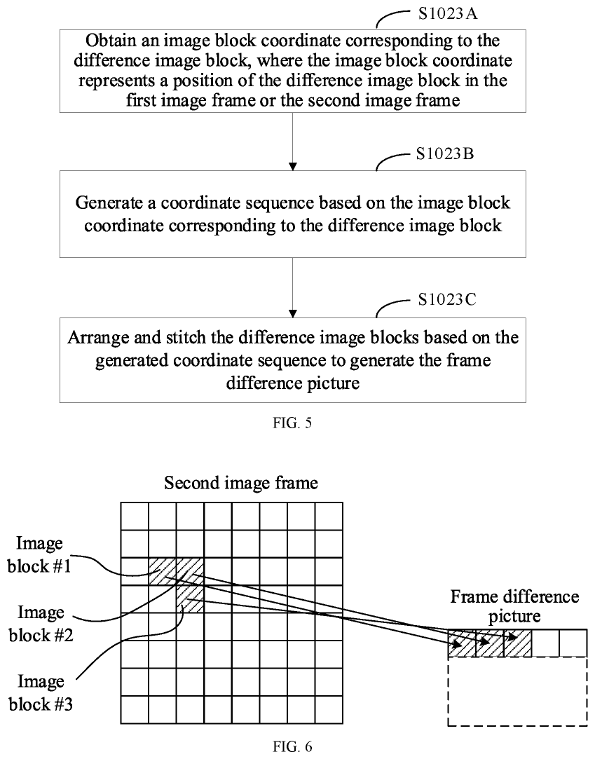

Further, after the difference image blocks are determined, in one possible implementation, a frame difference picture having the same dimensions as the second image frame is generated based on the positions of the difference image blocks in the second image frame. At pixel block positions corresponding to the above difference image blocks in the frame difference picture, pixels on the corresponding difference image blocks are copied. At the pixel block positions corresponding to the above non-difference image blocks in the frame difference picture, pixels with a transparency of 0 (fully transparent) are set. In another possible implementation, after the difference image blocks are determined, the difference image blocks are extracted and stitched to form a new picture, namely, the frame difference picture. In some embodiments, as shown in FIG. 5, the specific implementation steps of step S1023 include: steps S1023A to S1023C.

Step S1023A: Obtain an image block coordinate corresponding to the difference image block, where the image block coordinate represents a position of the difference image block in the first image frame or the second image frame.

Step S1023B: Generate a coordinate sequence based on the image block coordinate corresponding to the difference image block.

Step S1023C: Arrange and stitch the difference image blocks based on the generated coordinate sequence to generate the frame difference picture.

In some embodiments, FIG. 6 is a schematic diagram of generating a frame difference picture according to some embodiments of the present disclosure. As shown in FIG. 6, first, image block coordinates of the difference image blocks determined in the second image frame are obtained. For example, based on the 8×8 (8 rows and 8 columns) division rule, the coordinates of the image block #1 are (2,3), the coordinates of the image block #2 are (3,3), and the coordinates of the image block #3 are (3,4). Next, the above coordinates are saved as a coordinate sequence according to a preset rule. For example, the coordinates (2,3), (3,3), and (3,4) are saved as a coordinate sequence in a row-by-row order from left to right and from top to bottom, and then the image block #1, the image block #2, and the image block #3 are arranged and stitched in sequence to form the frame difference picture. Further, if the stitched difference image blocks do not fill an entire row, image blocks constructed based on special pixels, such as pure white, pure black, or transparent pixel blocks, may be filled to form a complete frame difference picture. In this embodiment, by arranging and stitching the difference image blocks, a frame difference picture with a smaller volume can be generated, thereby reducing the overall volume of the animation data.

In some embodiments, after generating the frame difference picture, specifically, after generating the frame difference picture through the arrangement and stitching method, the frame difference picture loses positioning information of the difference image blocks representing the differential content between the first image frame and the second image frame. Therefore, in order to achieve restoration of the differential content (difference image blocks) in the frame difference data, it is necessary to further generate restoration information corresponding to the frame difference picture. In some embodiments, step S1023 further includes: step S1023D.

Step S1023D: Generate restoration information based on the frame difference picture, where the restoration information is used to represent a position of the differential content in the frame difference picture within the second image frame.

In some embodiments, the restoration information is obtained based on image block sequence numbers and image block coordinates corresponding to the difference image blocks obtained during the generation of the frame difference picture, where the image block sequence number represents a position of the difference image block in the frame difference picture, and the image block coordinate represents a position of the difference image block in the second image frame. In one possible implementation, the restoration information includes a coordinate sequence, which is an array. Each element in the array corresponds to one image block in the second image frame. The position sequence number of the element in the array is the image block coordinate; and the numerical value of the element is the image block sequence number. For example, the coordinate sequence in the restoration information is [0,0,0,0,3,4,5,0,0]. The coordinate sequence includes 9 elements. According to a division specification (3×3 specification) of the first image frame (or the second image frame) recorded in the restoration information, the 9 elements in the coordinate sequence correspond to 9 image blocks in the second image frame, respectively. Among them, the first 4 elements in the coordinate sequence are “0”, indicating that the first 4 image blocks in the second image frame (scanned row by row from left to right and from top to bottom) are non-difference image blocks. The 5th element in the coordinate sequence is “3”, indicating that the 5th image block in the second image frame is a difference image block, and this difference image block is stored at a position with the image block sequence number “3” in the frame difference picture. The 6th to 9th elements in the coordinate sequence follow the same principle and will not be elaborated further. With the above restoration information, the restoration of the second image frame using the first image frame and the frame difference picture can be achieved.

In some embodiments, the restoration information may further include relevant information about the frame difference picture, which is used to describe the mapping relationship between image block sequence numbers and the positions of the difference image blocks in the frame difference picture. The specific implementation can be configured as needed and will not be elaborated further here.

Step S103: Generate animation data corresponding to the target animation based on the first image frame and the frame difference picture.

In some embodiments, based on the previous steps, after obtaining the frame difference picture, the animation data for the target animation may be generated based on the differential content of the second image frame relative to the first image frame, represented by the frame difference picture, and the first image frame itself. In one possible implementation, the animation data further includes restoration information for representing the position of the differential content in the frame difference picture within the first image frame. The animation data for the target animation is generated collectively by means of the restoration information, the first image frame, and the frame difference picture. The specific implementation of the restoration information has been described in detail in step S1023. Additionally, the animation data, which is a collection of the above first image frame, frame difference picture, and restoration information, can be further compressed, encoded, or processed in other ways to generate animation data in the form of a file. The specific implementation of packaging a plurality of files to generate a file is the related art known to those skilled in the art and can be configured as needed. This will not be elaborated further here.

In some embodiments, after the terminal device for playing the target animation obtains the animation data, it obtains the first image frame and the corresponding frame difference picture in the animation data by means of, for example, decoding, decompression, or other similar methods, and performs restoration to obtain the corresponding second image frame. Further, in some embodiments, if the set of images to be processed further includes other image frames in addition to the first image frame and the second image frame, the animation data further includes frame difference pictures corresponding to these other image frames (excluding the last image frame) in the set of images to be processed, for example, a frame difference picture corresponding to the second image frame, a frame difference picture corresponding to a third image frame, and the like. After obtaining the second image frame, the corresponding third image frame is restored further based on the frame difference picture corresponding to the second image frame. After obtaining the third image frame, the corresponding fourth image frame is restored further based on the frame difference picture corresponding to the third image frame, and so forth, until all the image frames in the set of images to be processed are obtained, thereby achieving the playback of the target animation.

This embodiment is implemented by obtaining a set of images to be processed, where the set of images to be processed includes at least a first image frame and a second image frame, where the first image frame is an animation start frame of a target animation, and the second image frame is a subsequent image frame adjacent to the first image frame; obtaining a frame difference picture based on the first image frame and the second image frame, where the frame difference picture represents a differential content of the second image frame relative to the first image frame; and generating animation data corresponding to the target animation based on the first image frame and the frame difference picture. By comparing the first image frame and the second image frame to obtain the frame difference picture, and leveraging the small data volume characteristic of the frame difference picture, the animation data of the target animation is generated by combining the frame difference picture with the animation start frame. Compared to the solution of generating animation data directly using the original second image frame, this reduces the data volume of the generated animation data while avoiding excessive compression of the animation data, thereby improving the image quality and visual effects of the target animation. At the same time, in the solution according to this embodiment, the step of processing the first image frame and the second image frame is easy to implement and has high versatility, and thus offers excellent compatibility, enabling cross-platform operation.

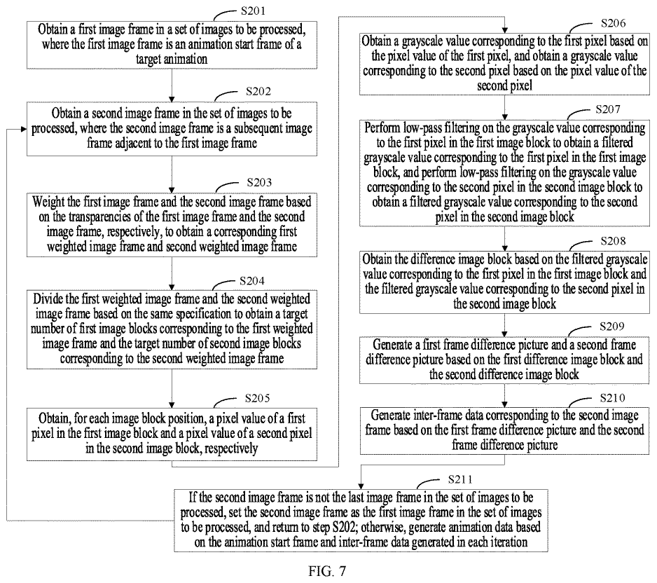

Referring to FIG. 7, FIG. 7 is a schematic flowchart of an animation data generation method according to some other embodiments of the present disclosure. In this embodiment, the further refinement of step S102 is described in detail on the basis of the embodiment shown in FIG. 2, with additional steps such as weighting processing of image frames included. The animation data generation method includes: steps S201 to S210.

Step S201: Obtain a first image frame in a set of images to be processed, where the first image frame is an animation start frame of a target animation.

Step S202: Obtain a second image frame in the set of images to be processed, where the second image frame is a subsequent image frame adjacent to the first image frame.

In some embodiment, the set of images to be processed includes at least two image frames, i.e., static images. The image frames are arranged in an ordered sequence, and their arrangement order may be determined, for example, based on their file names or other file attributes. The image frames are read in sequence based on the arrangement order thereof. That is, starting from the animation start frame, all image frames constituting the target animation can be obtained in sequence. Specifically, at the beginning of the first iteration, the first image frame in the set of images to be processed is the animation start frame, and the second image frame is the subsequent image frame adjacent to the animation start frame. For example, the first image frame is an image frame with an image sequence number [1] in the set of images to be processed, and the second image frame is an image frame with an image sequence number [2] in the set of images to be processed. In subsequent iterations, when the first image frame is updated, the second image frame is also updated accordingly. For example, when the first image frame is updated to the image frame with the image sequence number [2] in the set of images to be processed, the second image frame becomes an image frame with an image sequence number [3] in the set of images to be processed, and so forth.

Step S203: Weight the first image frame and the second image frame based on the transparencies of the first image frame and the second image frame, respectively, to obtain a corresponding first weighted image frame and second weighted image frame.

In some embodiments, the transparencies of the first image frame and the second image frame may refer to the transparencies of pixels in the first image frame and the second image frame, and may be represented by numerical matrices corresponding to the pixels in the image frames. That is, each numerical value in the matrix corresponds to a pixel in the image frame. Taking the first image frame as an example, the pixel values of pixels in the first image frame are represented based on RGBA, where RGBA is a color space model. R represents a red luminance channel, G indicates a green luminance channel, B indicates a blue luminance channel, and A indicates a transparency channel. Therefore, the pixel value corresponding to each pixel is [R,G,B,A]. The transparencies corresponding to the pixels in the first image frame can be obtained by using the A channel pixel values of the pixels.

Further, the color luminance values of the pixels are weighted in sequence based on the transparency values corresponding to the pixels of the first image frame to obtain weighted color luminance values corresponding to the pixels, as well as a set of pixels represented by the weighted color luminance values, namely, the first weighted image frame. The second weighted image frame is generated in the same way, which will not be elaborated further. For example, taking the first image frame as an example, for a P1 pixel in the first image frame, the corresponding pixel value is [100,221,75,255], where the P1 pixel has an R-channel luminance value of 100, a G-channel luminance value of 221, a B-channel luminance value of 75, and an A-channel transparency value of 255. For a P2 pixel in the first image frame, the corresponding pixel value is [76,111,154,1], where the P2 pixel has an R-channel luminance value of 76, a G-channel luminance value of 111, a B-channel luminance value of 154, and an A-channel transparency value of 1. After performing weighting calculations for the P1 and P2 pixels based on the transparency values, a weighted color luminance value corresponding to the P1 pixel of [100,221,75] and a weighted color luminance value corresponding to the P2 pixel of [76/255,111/255,154/255] are respectively obtained. In some embodiments, the maximum value of each channel of an RGBA pixel is 255. In the above example, the A-channel transparency value of the P1 pixel is 255, indicating that the P1 pixel is completely opaque, while the A-channel transparency value of the P2 pixel is 1, indicating that the P2 pixel is almost transparent. In this case, since completely transparent and almost transparent pixels do not cause significant visual changes even if there are changes in color luminance, after performing weighting calculations for the color luminance values of the pixels based on the transparency values, the color luminance values of the pixels are reduced, which can reduce the number of difference pixels (namely, differential contents) in the first image frame and the second image frame, thereby reducing information in the frame difference picture and further reducing the data volume of the generated animation data.

Of course, it is understandable that the above step S203 is optional. In a possible implementation, the above step S203 may not be performed, and the process can proceed directly to the subsequent step S204, namely, dividing the first image frame and the second image frame based on the same specification to obtain a target number of first image blocks corresponding to the first image frame and the target number of second image blocks corresponding to the second image frame. This will not be elaborated further here.

Step S204: Divide the first weighted image frame and the second weighted image frame based on the same specification to obtain a target number of first image blocks corresponding to the first weighted image frame and the target number of second image blocks corresponding to the second weighted image frame.

Step S205: Obtain, for each image block position, a pixel value of a first pixel in the first image block and a pixel value of a second pixel in the second image block, respectively.

In some embodiment, after obtaining the first weighted image frame and the second weighted image frame, the first weighted image frame and the second weighted image frame are divided based on the same division rule, thereby obtaining the same number of first image blocks and second image blocks. In one possible implementation, the first weighted image frame and the second weighted image frame are divided based on an 8×8 specification, thereby obtaining corresponding 64 first image blocks and second image blocks, respectively. The first image blocks and the second image blocks have the same dimensions. In some embodiments, each image block has the same length and width, and the length and the width of the image block are powers of 2. In this embodiment, the first weighted image frame and the second weighted image frame are divided based on the above specification, and the obtained first image blocks and second image blocks meet the requirements of the Joint Photographic Experts Group (JPEG) compression standard. Since the subsequent step needs to generate a picture in a JPEG format based on the first image blocks and the second image blocks, the division of the first weighted image frame and the second weighted image frame based on the above specification can improve the efficiency and quality of the compression of the picture in the subsequent step and improve the efficiency of generating animation data.

Further, based on the divided first image blocks and second image blocks, for each image block position, a pixel value of a first pixel in the first image block and a pixel value of a second pixel in the second image block are obtained, respectively. Specifically, for example, the first image frame has 64 first image blocks, and for each of the first image blocks, a pixel value of each pixel in the image block is obtained separately. In some embodiments, the pixel value of a pixel is represented based on an RGBA color space, where the pixel value of each pixel includes 4 channel values. For each first image block, the pixel values of the first pixels contained in it can be represented by a structure. The specific implementation has been described in step S203 above and will not be elaborated further here.

Step S206: Obtain a grayscale value corresponding to the first pixel based on the pixel value of the first pixel, and obtain a grayscale value corresponding to the second pixel based on the pixel value of the second pixel.

In some embodiments, the grayscale value calculation is performed based on the color luminance values of the first pixels in the first image block to obtain grayscale values corresponding to the first pixels. For example, the color luminance value of the first pixel is [R,G,B], then the corresponding grayscale value Gray is calculated as follows:

$$Gray = R \times 0.299 + G \times 0.587 + B \times 0.114$$

Similarly, the grayscale value calculation is performed based on the color luminance values of the second pixels in the second image block to obtain grayscale values corresponding to the second pixel. The specific process is the same and will not be elaborated further. In the steps of this embodiment, by converting the three-channel color luminance values of the pixels into the one-channel grayscale values for pixel difference comparison, the dimensionality of data comparison is reduced, so that the obtained frame difference picture has better stability, and the number of difference image blocks in the frame difference picture is reduced, thereby further reducing the volume of the animation data.

Step S207: Perform low-pass filtering on the grayscale value corresponding to the first pixel in the first image block to obtain a filtered grayscale value corresponding to the first pixel in the first image block, and perform low-pass filtering on the grayscale value corresponding to the second pixel in the second image block to obtain a filtered grayscale value corresponding to the second pixel in the second image block.

In some embodiments, after performing calculations separately for the pixels within the first image block and the second image block, grayscale values corresponding to the pixels are obtained, which is equivalent to obtaining a first grayscale image block and a second grayscale image block corresponding to the first image block and the second image block, respectively. All first image blocks in the first image frame becoming first grayscale image blocks and all second image blocks in the second image frame becoming second grayscale image blocks is equivalent to resulting in a first grayscale image corresponding to the first image frame and a second grayscale image corresponding to the second image frame. On this basis, low-pass filtering is further performed on first grayscale image blocks in the first grayscale image and second grayscale image blocks in the second grayscale image. That is, low-pass filtering is performed on the grayscale values corresponding to the first pixels in the first image blocks, and low-pass filtering is performed on the grayscale values corresponding to the second pixels in the second image blocks. This filters out high-frequency components in the first grayscale image blocks and the second grayscale image blocks, reducing noise and image elements that are difficult for human eyes to perceive. As a result, the consistency between the first grayscale image blocks and the corresponding second grayscale image blocks is improved, which reduces the number of subsequent difference image blocks, thereby achieving data compression without affecting visual effects. This further reduces the data volumes of the frame difference picture and the finally generated animation data.

In some embodiments, the specific implementation of performing low-pass filtering on the grayscale values corresponding to the first pixels in the first image blocks may involve, for example, performing a discrete cosine transform (DCT) on the grayscale values, followed by windowing to filter out high-frequency features in a frequency-domain dimension, thereby achieving the purpose of low-pass filtering. The specific filtering parameters may be set according to specific needs without limitation. The specific implementation is related art and will not be elaborated further here.

Step S208: Obtain the difference image block based on the filtered grayscale value corresponding to the first pixel in the first image block and the filtered grayscale value corresponding to the second pixel in the second image block.

In some embodiment, after obtaining the filtered grayscale values corresponding to the pixels (first pixels) in the first image block and the filtered grayscale values corresponding to the pixels (second pixels) in the second image block, average grayscale values corresponding to the first image block and the second image block are calculated, respectively. The method of calculating the average grayscale value, for example, includes: obtaining the filtered grayscale values corresponding to the pixels in the first image block, and calculating an average value to obtain the average grayscale value. On this basis, further based on a distance of each pixel to the center of the first image block, a weighting coefficient inversely proportional to the above distance can also be generated, and weighting calculation can be performed on the filtered grayscale value of the corresponding first pixel based on the weighting coefficient to obtain a corresponding weighted filtered grayscale value. Then, the average grayscale value is calculated based on the weighted filtered grayscale values corresponding to the first pixels in the first image block. The method for calculating the average grayscale value corresponding to the second image block is the same as that for the average grayscale value corresponding to the first image block, and will not be elaborated further.

Next, a difference between the average grayscale value of each first image block and the average grayscale value of the corresponding second image block is calculated. If the obtained difference is greater than a first threshold, the first image block and the second image block are considered to be difference image blocks. Conversely, if the obtained difference is less than the first threshold, the first image block and the second image block are considered to be non-difference image blocks, i.e., image blocks having the same image content.

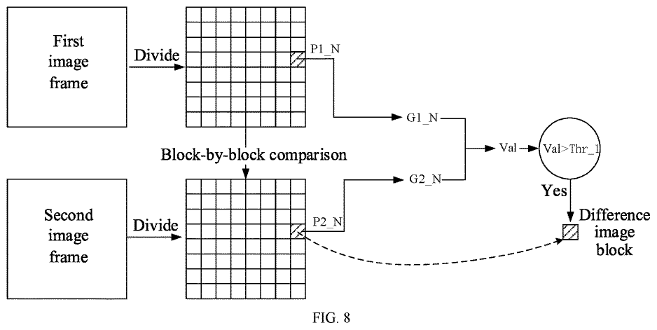

FIG. 8 is a schematic diagram of a process of determining a difference image block according to an embodiment of the present disclosure. As shown in FIG. 8, after the first image frame and the second image frame are divided based on the 8×8 (8 rows and 8 columns) specification, 64 first image blocks corresponding to the first image frame and 64 second image blocks corresponding to the second image frame are obtained, respectively. The first image blocks are in a one-to-one correspondence with the second image blocks, that is, each first image block and the corresponding second image block form an image block group. Next, each image block group is traversed, and the average grayscale value corresponding to the first image blocks and the average grayscale value corresponding to the second image blocks in the image block groups are calculated separately. For example, as shown in FIG. 8, an image block group P_N includes a first image block P1_N and a second image block P2_N, where N indicates the image block sequence number of the first image block and the second image block in their respective image frames. After obtaining an average grayscale value G1_N of the first image block P1_N and an average grayscale value G2_N of the second image block P2_N, a difference absolute value Val between G1_N and G2_N is calculated. If the difference absolute value Val is greater than a first threshold Thr_1, the image block corresponding to the image block group P_N is a difference image block, that is, the second image block P2_N of the image block group P_N is regarded as a difference image block. Conversely, if the difference absolute value Val is less than the first threshold thr_1, the image block corresponding to the image block group P_N is a non-difference image block, that is, the first image block P1_N and the second image block P2_N are considered to be the same. The first threshold is set as needed, and is not specifically defined here.

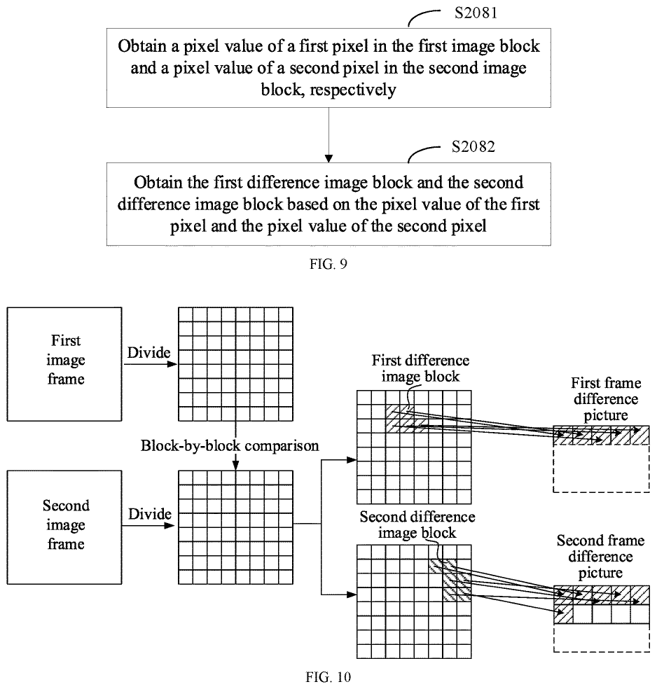

In one possible implementation, the difference image block includes a first difference image block and a second difference image block, where the first difference image block is an image block having a color luminance difference, and the second difference image block is an image block having a transparency difference. As shown in FIG. 9, a specific implementation of step S208 includes: steps S2081 and S2082.

Step S2081: Obtain a pixel value of a first pixel in the first image block and a pixel value of a second pixel in the second image block, respectively.

Step S2082: Obtain the first difference image block and the second difference image block based on the pixel value of the first pixel and the pixel value of the second pixel.

In some embodiments, the pixel value includes three-channel color luminance values and a one-channel transparency value. The specific implementation steps of step S2082 include: steps S2082A and S2082B.

Step S2082A: Obtain the first difference image block based on color luminance values of the first pixel in the first image block and color luminance values of the corresponding second pixel in the second image block.

Step S2082B: Obtain the second difference image block based on a transparency value of the first pixel in the first image block and a transparency value of the corresponding second pixel in the second image block.

In some embodiment, the pixel values of the first pixel and the second pixel are represented based on the RGBA color space model. R, G, and B respectively represent a red luminance value, a green luminance value, and a blue luminance value, and A represents a transparency value. On the one hand, after obtaining the pixel values of the first pixels in the first image block and the second pixels in the second image block, grayscale values corresponding to the pixels are calculated based on RGB values. Then, average grayscale values corresponding to the first image block and the second image block are obtained separately. After comparing the average grayscale values, a first difference image block can be obtained. The method for obtaining the first difference image block is the same as the method for obtaining the difference image block described in the above steps S204 to S208 and will not be elaborated further here.

On the other hand, after obtaining the pixel values of the first pixels in the first image block and the second pixels in the second image block, transparency values corresponding to the pixels are obtained based on A values. Then, average transparency values respectively corresponding to the first image block and the second image block are calculated. Subsequently, by comparing the first image block and the second image block based on the average transparency values, a second difference image block can be obtained. The specific implementation of calculating the average transparency value is similar to the implementation of calculating the average grayscale value corresponding to an image block described in the above embodiment steps, namely, performing an averaging calculation or a weighted averaging calculation on the transparency values corresponding to the pixels in the image block to obtain the average transparency value corresponding to the image block. With reference to the relevant description of the calculation of the average grayscale value in the above embodiment steps, a difference is then calculated based on the average transparency values to obtain a transparency difference value. If the transparency difference value is greater than a second threshold, it is considered that the transparency has changed, and the second image block is determined to be the second difference image block. The specific process is similar to the method for determining the difference image block described in the above embodiment steps. For details, reference may be made to the description of determining the difference image block in the above embodiment steps, which will not be elaborated further here.

Step S209: Generate a first frame difference picture and a second frame difference picture based on the first difference image block and the second difference image block.

In some embodiments, based on the above steps, at least one first difference image block and at least one second difference image block can be obtained. Then, by stitching the at least one first difference image block and the at least one second difference image block, respectively, a first frame difference picture formed by arranging and stitching the first difference image block and a second frame difference picture formed by arranging and stitching the second difference image block may be obtained. The first frame difference picture represents a color luminance difference of the second image frame relative to the first image frame. The second frame difference picture represents a transparency difference of the second image frame relative to the first image frame.

FIG. 10 is a schematic diagram of a process of generating a first frame difference picture and a second frame difference picture according to some embodiments of the present disclosure. As shown in FIG. 10, after obtaining the first image frame and the second image frame, and the first image frame and the second image frame are divided into blocks and compared block by block, the first difference image blocks and the second difference image blocks are obtained. Then, the first difference image blocks and the second difference image blocks are respectively arranged and stitched to generate the corresponding first frame difference picture and second frame difference picture. In some embodiments, the first frame difference picture is in the Joint Photographic Experts Group (JPEG) image format; and the second frame difference picture is in a Portable Network Graphics (PNG) image format. In the steps of this embodiment, by setting the first frame difference picture to the Joint Photographic Experts Group image format and the second frame difference picture to the Portable Network Graphics image format, the characteristic that the JPEG image format has a better compression ratio than the PNG image format is utilized to further improve the efficiency of image compression and reduce the data volume of the generated animation data.

Further, while generating the first difference image block and the second difference image, corresponding restoration information for describing the respective positions of the first difference image block and the second difference image in the second image frame is also generated. The specific implementation of the restoration information has been described in the above embodiments. On this basis, in a coordinate sequence in the restoration information, the first difference image block and the second difference image are distinguished by the signs of the element values. For example, the coordinate sequence in the restoration information is [0,0,0,0,3,−4,5,0,0] (for specific meanings, reference may be made to the detailed description in step S1023D), where the 5th element “3” indicates that the 5th image block in the second image frame is a difference image block, and this difference image block is stored at a position having an image block sequence number “3” in the first frame difference picture; and the 6th element “−4” indicates that the 6th image block in the second image frame is a difference image block, and this difference image block is stored at a position having an image block sequence number “4” in the second frame difference picture. In this embodiment, the difference image blocks in the first frame difference picture and the second frame difference picture are distinguished by the signs in the coordinate sequence, thereby further improving the information storage efficiency of the restoration information.

In this embodiment, by respectively obtaining the first difference image block and the second difference image block and generating the first frame difference picture and the second frame difference picture, differential contents between the first image frame and the second image frame in two dimensions of the color luminance value and the transparency value are obtained. This enables the target animation corresponding to the animation data to exhibit changes in transparency between the image frames, thereby further improving the visual effect of the animation.

Step S210: Generate inter-frame data corresponding to the second image frame based on the first frame difference picture and the second frame difference picture.

Step S211: If the second image frame is not the last image frame in the set of images to be processed, set the second image frame as the first image frame in the set of images to be processed, and return to step S202; otherwise, generate animation data based on the animation start frame and inter-frame data generated in each iteration.

Further, the inter-frame data corresponding to the second image frame is obtained based on the first frame difference picture and the second frame difference picture. This inter-frame data may be considered as temporary data before generating animation data. If the second image frame is not the last image frame in the set of images to be processed, the second image frame is set as the first image frame in the set of images to be processed. That is, the first image frame is updated, and the process moves to the next image frame in the set of images to be processed, continues processing the subsequent image frame, and obtains inter-frame data corresponding to the updated second image frame, namely, the first frame difference picture and the second frame difference picture corresponding to the second image frame, and the restoration information. The above iteration is repeated until the second image frame becomes the last image frame in the set of images to be processed. At this point, the inter-frame data corresponding to the second image frames obtained in all iterations and the restoration information are merged, and in conjunction with the animation start frame, to generate the final animation data.

In some embodiments, a specific implementation of merging the inter-frame data may be as follows: After the last iteration (that is, the second image frame is the last image frame in the set of images to be processed), the first frame difference pictures and second frame difference pictures in the inter-frame data obtained in the various iterations are merged into one first frame difference picture and one second frame difference picture. At the same time, the coordinate sequences in the restoration information are merged accordingly. Alternatively, after each iteration, the first frame difference picture and the second frame difference picture obtained in the current iteration are merged to the first frame difference picture and the second frame difference picture obtained in the previous iteration to obtain the updated first frame difference picture and second frame difference picture, namely, updated inter-frame data. This process continues until the iteration ends. The restoration information is processed in a similar manner, which will not be elaborated further.

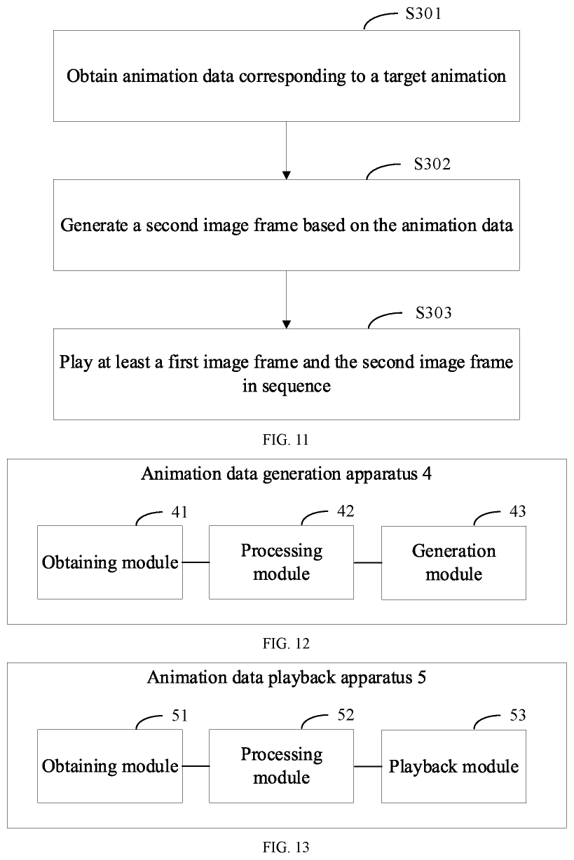

FIG. 11 is a schematic flowchart of an animation data playback method according to some embodiments of the present disclosure. The method of this embodiment can be applied in a terminal device. The animation data playback method includes: steps S301 to S303.

Step S301: Obtain animation data corresponding to a target animation.

Step S302: Generate a second image frame based on the animation data.

Step S303: Play at least a first image frame and the second image frame in sequence.

In some embodiment, reference is made to the schematic diagram of the application scenario shown in FIG. 1 and to the process of generating animation data in the above embodiments. The terminal device obtains animation data from, for example, a server. The animation data is generated through the animation data generation method according to any of the embodiments corresponding to FIG. 2 to FIG. 10. In particular, the animation data includes the first image frame and a frame difference picture, where the first image frame is an animation start frame of the target animation, the frame difference picture represents a differential content of the second image frame relative to the first image frame, and the second image frame is a subsequent image frame adjacent to the first image frame. After obtaining the animation data, the terminal device parses the animation data and obtains at least the first image frame and the frame difference picture contained in the animation data. It then performs restoration using the first image frame and the frame difference picture to obtain the corresponding second image frame. Subsequently, at least the first image frame and the second image frame are played in sequence to achieve a dynamic playback effect of the pictures, that is, playing the target animation. The specific implementation of the frame difference picture has been described in detail in the embodiments corresponding to FIG. 2 to FIG. 10, and will not be elaborated further here.

Further, optionally, the animation data further includes restoration information, where the restoration information is used to represent a position of the differential content in the frame difference picture within the second image frame. The specific implementation of the restoration information has been described in detail in the embodiments corresponding to FIG. 2 to FIG. 10, and will not be elaborated further here.

Further, optionally, the animation data includes the first image frame, a first frame difference picture, and a second frame difference picture, where the first frame difference picture represents a color luminance difference of the second image frame relative to the first image frame; and the second frame difference picture represents a transparency difference of the second image frame relative to the first image frame. A specific implementation of step S302 includes: steps S3021 to S3022.

Step S3021: Obtain the first image frame in the animation data.

Step S3022: Generate the second image frame based on the first image frame, the first frame difference picture, and the second frame difference picture.

In some embodiments, the animation data further contains restoration information, where the restoration information includes a coordinate sequence, which is an array. Each element in the array corresponds to one image block in the second image frame. The position sequence number of the element in the array is the image block coordinate; and the numerical value of the element is the image block sequence number. By means of the restoration information, the difference image blocks in the first frame difference picture and the second frame difference picture may be respectively mapped to and overlay corresponding positions (corresponding image blocks) in the first image frame, thereby quickly restoring the second image frame. The specific implementation and technical effects of the restoration information have been described in detail in the embodiments corresponding to FIG. 2 to FIG. 10, and will not be elaborated further here.

In this embodiment, the first image frame and the second image frame are restored by using the image data generated in the embodiments corresponding to FIG. 2 to FIG. 10, and the first image frame and the second image frame are played in sequence, thereby implementing playback of the target animation. Since the image data has the advantages of small data volume and high image quality, using the image data for target animation playback can reduce the occupation of storage and network resources, and improve the loading speed and visual effects of the target animation.

Corresponding to the animation data generation method in the above embodiments, FIG. 12 is a block diagram of a structure of an animation data generation apparatus according to an embodiment of the present disclosure. For ease of illustration, only parts related to this embodiment of the present disclosure are shown. Referring to FIG. 12, an animation data generation apparatus 4 includes: an obtaining module 41, a processing module 42, and a generation module 43.

The obtaining module 41 is configured to obtain a set of images to be processed, where the set of images to be processed includes at least a first image frame and a second image frame, where the first image frame is an animation start frame of a target animation, and the second image frame is a subsequent image frame adjacent to the first image frame.

The processing module 42 is configured to obtain a frame difference picture based on the first image frame and the second image frame, where the frame difference picture represents a differential content of the second image frame relative to the first image frame.

The generation module 43 is configured to generate animation data corresponding to the target animation based on the first image frame and the frame difference picture.

In one embodiment of the present disclosure, the animation data includes a first frame difference picture and a second frame difference picture, where the first frame difference picture represents a color luminance difference of the second image frame relative to the first image frame; and the second frame difference picture represents a transparency difference of the second image frame relative to the first image frame.

In one embodiment of the present disclosure, the first frame difference picture is in a Joint Photographic Experts Group (JPEG) image format; and the second frame difference picture is in a Portable Network Graphics (PNG) image format.

In one embodiment of the present disclosure, the processing module 42 is specifically configured to: divide the first image frame and the second image frame based on the same specification to obtain a target number of first image blocks corresponding to the first image frame and the target number of second image blocks corresponding to the second image frame; compare first image blocks and second image blocks at the same image block positions in the first image frame and the second image frame to obtain at least one difference image block, where the difference image block is a second image block different from a first image block at the same image block position; and generate the frame difference picture based on the difference image block.

In one embodiment of the present disclosure, the processing module 42, when comparing first image blocks and second image blocks at the same image block positions in the first image frame and the second image frame to obtain at least one difference image block, is specifically configured to: obtain, for each image block position, a pixel value of a first pixel in the first image block and a pixel value of a second pixel in the second image block, respectively; obtain a grayscale value corresponding to the first pixel based on the pixel value of the first pixel; obtain a grayscale value corresponding to the second pixel based on the pixel value of the second pixel; and obtain the difference image block based on the grayscale value corresponding to the first pixel in the first image block and the grayscale value corresponding to the second pixel in the second image block.

In one embodiment of the present disclosure, the processing module 42, when obtaining the difference image block based on the grayscale value corresponding to the first pixel in the first image block and the grayscale value corresponding to the second pixel in the second image block, is specifically configured to: obtain a first average grayscale value corresponding to the first image block based on the grayscale value corresponding to the first pixel in the first image block; obtain a second average grayscale value corresponding to the second image block based on the grayscale value corresponding to the second pixel in the second image block; and obtain the difference image block based on the first average grayscale value and the second average grayscale value.

In one embodiment of the present disclosure, the processing module 42 is further configured to: perform low-pass filtering on the grayscale value corresponding to the first pixel in the first image block to obtain a filtered grayscale value corresponding to the first pixel in the first image block; and perform low-pass filtering on the grayscale value corresponding to the second pixel in the second image block to obtain a filtered grayscale value corresponding to the second pixel in the second image block; and the processing module 42, when obtaining the difference image block based on the grayscale value corresponding to the first pixel in the first image block and the grayscale value corresponding to the second pixel in the second image block, is specifically configured to: obtain the difference image block based on the filtered grayscale value corresponding to the first pixel in the first image block and the filtered grayscale value corresponding to the second pixel in the second image block.

In one embodiment of the present disclosure, the processing module 42, when generating the frame difference picture based on the difference image block, is specifically configured to: obtain an image block coordinate corresponding to the difference image block, where the image block coordinate represents a position of the difference image block in the first image frame or the second image frame; generate a coordinate sequence based on the image block coordinate corresponding to the difference image block; and arrange and stitch the difference image blocks based on the generated coordinate sequence to generate the frame difference picture.

In one embodiment of the present disclosure, the difference image block includes a first difference image block and a second difference image block, where the first difference image block is an image block having a color luminance difference, and the second difference image block is an image block having a transparency difference; and the processing module 42, when comparing first image blocks and second image blocks at the same block positions in the first image frame and the second image frame to obtain at least one difference image block, is specifically configured to: obtain a pixel value of a first pixel in the first image block and a pixel value of a second pixel in the second image block, respectively; and obtain the first difference image block and the second difference image block based on the pixel value of the first pixel and the pixel value of the second pixel.

In one embodiment of the present disclosure, the pixel value includes three-channel color luminance values and a one-channel transparency value; and the processing module 42, when obtaining the first difference image block and the second difference image block based on the pixel value of the first pixel and the pixel value of the second pixel, is specifically configured to: obtain the first difference image block based on color luminance values of the first pixel in the first image block and color luminance values of the corresponding second pixel in the second image block; and obtain the second difference image block based on a transparency value of the first pixel in the first image block and a transparency value of the corresponding second pixel in the second image block.

In one embodiment of the present disclosure, the processing module 42 is further configured to: generate restoration information based on the frame difference picture, where the restoration information is used to represent a position of the differential content in the frame difference picture within the second image frame; and the generation module 43 is specifically configured to: generate the animation data corresponding to the target animation based on the first image frame, the frame difference picture, and the restoration information.

In one embodiment of the present disclosure, the processing module 42 is further configured to: obtain transparency values corresponding to pixels in the first image frame and the second image frame; and weight, based on the transparency values, color luminance values corresponding to the pixels in the first image frame and the second image frame to obtain a first weighted image frame corresponding to the first image frame and a second weighted image frame corresponding to the second image frame; and the processing module 42, when obtaining a frame difference picture based on the first image frame and the second image frame, is specifically configured to: obtain the frame difference picture based on the first weighted image frame and the second weighted image frame.

The obtaining module 41, the processing module 42, and the generation module 43 are connected in sequence. The animation data generation apparatus 4 according to this embodiment can perform the technical solution of the above method embodiments corresponding to FIG. 2 to FIG. 10. The implementation principles and technical effects thereof are similar, which are not elaborated further in this embodiment.

Corresponding to the animation data playback method of the above embodiments, FIG. 13 is a block diagram of a structure of an animation data playback apparatus according to an embodiment of the present disclosure. For ease of illustration, only parts related to this embodiment of the present disclosure are shown. Referring to FIG. 13, an animation data playback apparatus 5 includes: an obtaining module 51, a processing module 52, and a playback module 53.

The obtaining module 51 is configured to obtain animation data corresponding to a target animation, where the animation data is generated by the animation data generation method according to any of the above embodiments corresponding to FIG. 2 to FIG. 10.

The processing module 52 is configured to obtain a first image frame and a second image frame based on the animation data, where the first image frame is an animation start frame of the target animation, and the second image frame is a subsequent image frame adjacent to the first image frame.

The playback module 53 is configured to play at least the first image frame and the second image frame in sequence.

In one embodiment of the present disclosure, the animation data further includes restoration information, where the restoration information is used to represent a position of the differential content in the frame difference picture within the second image frame.

In one embodiment of the present disclosure, the animation data includes the first image frame, a first frame difference picture, and a second frame difference picture, where the first frame difference picture represents a color luminance difference of the second image frame relative to the first image frame; and the second frame difference picture represents a transparency difference of the second image frame relative to the first image frame. The processing module 52 is specifically configured to: obtain the first image frame in the animation data; and generate the second image frame based on the first image frame, the first frame difference picture, and the second frame difference picture.

The obtaining module 51, the processing module 52, and the playback module 53 are connected in sequence. The animation data playback apparatus 5 according to this embodiment can perform the technical solution of the above method embodiment corresponding to FIG. 11. The implementation principles and technical effects thereof are similar, which are not elaborated further in this embodiment.

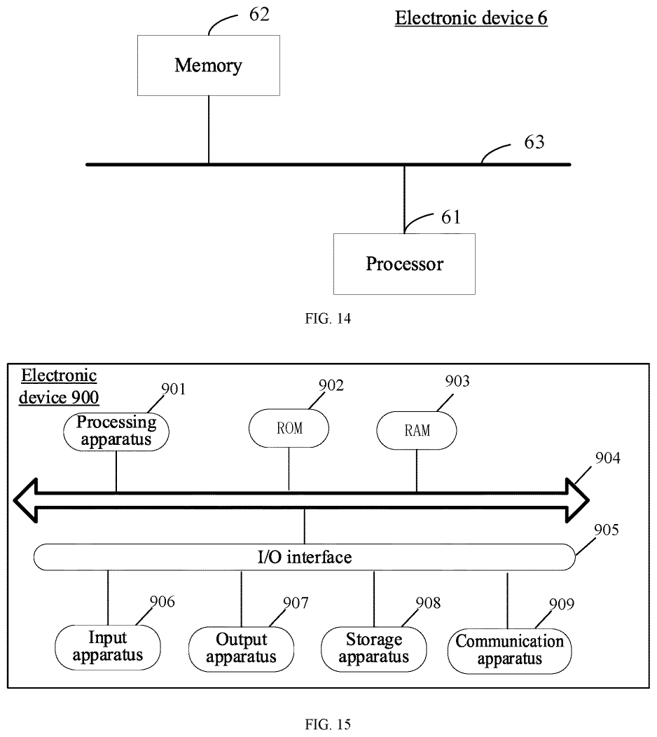

FIG. 14 is a schematic diagram of a structure of an electronic device according to an embodiment of the present disclosure. As shown in FIG. 14, an electronic device 6 includes:

a processor 61, and a memory 62 communicatively connected to the processor 61, where the memory 62 stores computer-executable instructions; and

the processor 61 executes the computer-executable instructions stored in the memory 62 to implement the animation data generation method in the embodiments shown in FIG. 2 to FIG. 10, or implement the animation data playback method in the embodiment shown in FIG. 11.

Optionally, the processor 61 and the memory 62 are connected through a bus 63.

The related illustration may be understood with reference to related description and effects that correspond to the steps in the embodiments corresponding to FIG. 2 to FIG. 11, which are not elaborated further here.

An embodiment of the present disclosure provides a computer-readable storage medium storing computer-executable instructions that, when executed by a processor, cause the animation data generation method in the embodiment shown in FIG. 2 to FIG. 10 or the animation data playback method in the embodiment shown in FIG. 11 to be implemented.

An embodiment of the present disclosure provides a computer program product including a computer program that, when executed by a processor, causes the animation data generation method in the embodiment shown in FIG. 2 to FIG. 10 or the animation data playback method in the embodiment shown in FIG. 11 to be implemented.

Referring to FIG. 15, which shows a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and an in-vehicle-mounted terminal (such as a vehicle navigation terminal), and a fixed terminal such as a digital TV and a desktop computer. The electronic device shown in FIG. 15 is merely an example, and shall not impose any limitation on the function and scope of use of the embodiments of the present disclosure.

As shown in FIG. 15, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 15 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 909, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, an animation data generation method is provided, including:
obtaining a set of images to be processed, where the set of images to be processed includes at least a first image frame and a second image frame, where the first image frame is an animation start frame of a target animation, and the second image frame is a subsequent image frame adjacent to the first image frame; obtaining a frame difference picture based on the first image frame and the second image frame, where the frame difference picture represents a differential content of the second image frame relative to the first image frame; and generating animation data corresponding to the target animation based on the first image frame and the frame difference picture.

According to one or more embodiments of the present disclosure, the animation data includes a first frame difference picture and a second frame difference picture, where the first frame difference picture represents a color luminance difference of the second image frame relative to the first image frame; and the second frame difference picture represents a transparency difference of the second image frame relative to the first image frame.

According to one or more embodiments of the present disclosure, the first frame difference picture is in a Joint Photographic Experts Group (JPEG) image format; and the second frame difference picture is in a Portable Network Graphics (PNG) image format.

According to one or more embodiments of the present disclosure, the obtaining a frame difference picture based on the first image frame and the second image frame includes: dividing the first image frame and the second image frame based on the same specification to obtain a target number of first image blocks corresponding to the first image frame and the target number of second image blocks corresponding to the second image frame; comparing first image blocks and second image blocks at the same image block positions in the first image frame and the second image frame to obtain at least one difference image block, where the difference image block is a second image block different from a first image block at the same image block position; and generating the frame difference picture based on the difference image block.

According to one or more embodiments of the present disclosure, the comparing first image blocks and second image blocks at the same image block positions in the first image frame and the second image frame to obtain at least one difference image block includes: obtaining, for each image block position, a pixel value of a first pixel in the first image block and a pixel value of a second pixel in the second image block, respectively; obtaining a grayscale value corresponding to the first pixel based on the pixel value of the first pixel; obtaining a grayscale value corresponding to the second pixel based on the pixel value of the second pixel; and obtaining the difference image block based on the grayscale value corresponding to the first pixel in the first image block and the grayscale value corresponding to the second pixel in the second image block.

According to one or more embodiments of the present disclosure, the obtaining the difference image block based on the grayscale value corresponding to the first pixel in the first image block and the grayscale value corresponding to the second pixel in the second image block includes: obtaining a first average grayscale value corresponding to the first image block based on the grayscale value corresponding to the first pixel in the first image block; obtaining a second average grayscale value corresponding to the second image block based on the grayscale value corresponding to the second pixel in the second image block; and obtaining the difference image block based on the first average grayscale value and the second average grayscale value.

According to one or more embodiments of the present disclosure, the method further includes: performing low-pass filtering on the grayscale value corresponding to the first pixel in the first image block to obtain a filtered grayscale value corresponding to the first pixel in the first image block; and performing low-pass filtering on the grayscale value corresponding to the second pixel in the second image block to obtain a filtered grayscale value corresponding to the second pixel in the second image block; and the obtaining the difference image block based on the grayscale value corresponding to the first pixel in the first image block and the grayscale value corresponding to the second pixel in the second image block includes: obtaining the difference image block based on the filtered grayscale value corresponding to the first pixel in the first image block and the filtered grayscale value corresponding to the second pixel in the second image block.

According to one or more embodiments of the present disclosure, the generating the frame difference picture based on the difference image block includes: obtaining an image block coordinate corresponding to the difference image block, where the image block coordinate represents a position of the difference image block in the first image frame or the second image frame; generating a coordinate sequence based on the image block coordinate corresponding to the difference image block; and arranging and stitching the difference image block based on the generated coordinate sequence to generate the frame difference picture.

According to one or more embodiments of the present disclosure, the difference image block includes a first difference image block and a second difference image block, where the first difference image block is an image block having a color luminance difference, and the second difference image block is an image block having a transparency difference; and the comparing first image blocks and second image blocks at the same block positions in the first image frame and the second image frame to obtain at least one difference image block includes: obtaining a pixel value of a first pixel in the first image block and a pixel value of a second pixel in the second image block, respectively; and obtaining the first difference image block and the second difference image block based on the pixel value of the first pixel and the pixel value of the second pixel.

According to one or more embodiments of the present disclosure, the pixel value includes three-channel color luminance values and a one-channel transparency value; and the obtaining the first difference image block and the second difference image block based on the pixel value of the first pixel and the pixel value of the second pixel includes: obtaining the first difference image block based on color luminance values of the first pixel in the first image block and color luminance values of the corresponding second pixel in the second image block; and obtaining the second difference image block based on a transparency value of the first pixel in the first image block and a transparency value of the corresponding second pixel in the second image block.

According to one or more embodiments of the present disclosure, the method further includes: generating restoration information based on the frame difference picture, where the restoration information is used to represent a position of the differential content in the frame difference picture within the second image frame; and the generating animation data corresponding to the target animation based on the first image frame and the frame difference picture includes: generating the animation data corresponding to the target animation based on the first image frame, the frame difference picture, and the restoration information.

According to one or more embodiments of the present disclosure, the method further includes: obtaining transparency values corresponding to pixels in the first image frame and the second image frame; and weighting, based on the transparency values, color luminance values corresponding to the pixels in the first image frame and the second image frame to obtain a first weighted image frame corresponding to the first image frame and a second weighted image frame corresponding to the second image frame; and the obtaining a frame difference picture based on the first image frame and the second image frame includes: obtaining the frame difference picture based on the first weighted image frame and the second weighted image frame.

In a second aspect, according to one or more embodiments of the present disclosure, an animation data playback method is provided, including: obtaining animation data corresponding to a target animation, where the animation data is generated by the animation data generation method as described in the above first aspect and various possible designs of the first aspect; obtaining a first image frame and a second image frame based on the animation data, where the first image frame is an animation start frame of the target animation, and the second image frame is a subsequent image frame adjacent to the first image frame; and playing at least the first image frame and the second image frame in sequence.

In one embodiment of the present disclosure, the animation data further includes restoration information, where the restoration information is used to represent a position of the differential content in the frame difference picture within the second image frame.

According to one or more embodiments of the present disclosure, the animation data includes the first image frame, a first frame difference picture, and a second frame difference picture, where the first frame difference picture represents a color luminance difference of the second image frame relative to the first image frame, and the second frame difference picture represents a transparency difference of the second image frame relative to the first image frame; and the obtaining a first image frame and a second image frame based on the animation data includes: obtaining the first image frame in the animation data; and generating the second image frame based on the first image frame, the first frame difference picture, and the second frame difference picture.

In a third aspect, according to one or more embodiments of the present disclosure, an animation data generation apparatus is provided, including:
an obtaining module configured to obtain a set of images to be processed, where the set of images to be processed includes at least a first image frame and a second image frame, where the first image frame is an animation start frame of a target animation, and the second image frame is a subsequent image frame adjacent to the first image frame;
a processing module configured to obtain a frame difference picture based on the first image frame and the second image frame, where the frame difference picture represents a differential content of the second image frame relative to the first image frame; and
a generation module configured to generate animation data corresponding to the target animation based on the first image frame and the frame difference picture.

According to one or more embodiments of the present disclosure, the animation data includes a first frame difference picture and a second frame difference picture, where the first frame difference picture represents a color luminance difference of the second image frame relative to the first image frame; and the second frame difference picture represents a transparency difference of the second image frame relative to the first image frame.

According to one or more embodiments of the present disclosure, the first frame difference picture is in a Joint Photographic Experts Group (JPEG) image format; and the second frame difference picture is in a Portable Network Graphics (PNG) image format.

According to one or more embodiments of the present disclosure, the processing module is specifically configured to: divide the first image frame and the second image frame based on the same specification to obtain a target number of first image blocks corresponding to the first image frame and the target number of second image blocks corresponding to the second image frame; compare first image blocks and second image blocks at the same image block positions in the first image frame and the second image frame to obtain at least one difference image block, where the difference image block is a second image block different from a first image block at the same image block position; and generate the frame difference picture based on the difference image block.

According to one or more embodiments of the present disclosure, the processing module, when comparing first image blocks and second image blocks at the same image block positions in the first image frame and the second image frame to obtain at least one difference image block, is specifically configured to: obtain, for each image block position, a pixel value of a first pixel in the first image block and a pixel value of a second pixel in the second image block, respectively; obtain a grayscale value corresponding to the first pixel based on the pixel value of the first pixel; obtain a grayscale value corresponding to the second pixel based on the pixel value of the second pixel; and obtain the difference image block based on the grayscale value corresponding to the first pixel in the first image block and the grayscale value corresponding to the second pixel in the second image block.

According to one or more embodiments of the present disclosure, the processing module, when obtaining the difference image block based on the grayscale value corresponding to the first pixel in the first image block and the grayscale value corresponding to the second pixel in the second image block, is specifically configured to: obtain a first average grayscale value corresponding to the first image block based on the grayscale value corresponding to the first pixel in the first image block; obtain a second average grayscale value corresponding to the second image block based on the grayscale value corresponding to the second pixel in the second image block; and obtain the difference image block based on the first average grayscale value and the second average grayscale value.

According to one or more embodiments of the present disclosure, the processing module is further configured to: perform low-pass filtering on the grayscale value corresponding to the first pixel in the first image block to obtain a filtered grayscale value corresponding to the first pixel in the first image block; and perform low-pass filtering on the grayscale value corresponding to the second pixel in the second image block to obtain a filtered grayscale value corresponding to the second pixel in the second image block; and the processing module, when obtaining the difference image block based on the grayscale value corresponding to the first pixel in the first image block and the grayscale value corresponding to the second pixel in the second image block, is specifically configured to: obtain the difference image block based on the filtered grayscale value corresponding to the first pixel in the first image block and the filtered grayscale value corresponding to the second pixel in the second image block.

According to one or more embodiments of the present disclosure, the processing module, when generating the frame difference picture based on the difference image block, is specifically configured to: obtain an image block coordinate corresponding to the difference image block, where the image block coordinate represents a position of the difference image block in the first image frame or the second image frame; generate a coordinate sequence based on the image block coordinate corresponding to the difference image block; and arrange and stitching the difference image block based on the generated coordinate sequence to generate the frame difference picture.

According to one or more embodiments of the present disclosure, the difference image block includes a first difference image block and a second difference image block, where the first difference image block is an image block having a color luminance difference, and the second difference image block is an image block having a transparency difference; and the processing module, when comparing first image blocks and second image blocks at the same block positions in the first image frame and the second image frame to obtain at least one difference image block, is specifically configured to: obtain a pixel value of a first pixel in the first image block and a pixel value of a second pixel in the second image block, respectively; and obtain the first difference image block and the second difference image block based on the pixel value of the first pixel and the pixel value of the second pixel.

According to one or more embodiments of the present disclosure, the pixel value includes three-channel color luminance values and a one-channel transparency value; and the processing module, when obtaining the first difference image block and the second difference image block based on the pixel value of the first pixel and the pixel value of the second pixel, is specifically configured to: obtain the first difference image block based on color luminance values of the first pixel in the first image block and color luminance values of the corresponding second pixel in the second image block; and obtain the second difference image block based on a transparency value of the first pixel in the first image block and a transparency value of the corresponding second pixel in the second image block.

According to one or more embodiments of the present disclosure, the processing module is further configured to: generate restoration information based on the frame difference picture, where the restoration information is used to represent a position of the differential content in the frame difference picture within the second image frame; and the generation module is specifically configured to: generate the animation data corresponding to the target animation based on the first image frame, the frame difference picture, and the restoration information.

According to one or more embodiments of the present disclosure, the processing module is further configured to: obtain transparency values corresponding to pixels in the first image frame and the second image frame; and weight, based on the transparency values, color luminance values corresponding to the pixels in the first image frame and the second image frame to obtain a first weighted image frame corresponding to the first image frame and a second weighted image frame corresponding to the second image frame; and the processing module, when obtaining a frame difference picture based on the first image frame and the second image frame, is specifically configured to: obtaining the frame difference picture based on the first weighted image frame and the second weighted image frame.

In a fourth aspect, according to one or more embodiments of the present disclosure, an animation data playback apparatus is provided, including:
an obtaining module configured to obtain animation data corresponding to a target animation, where the animation data is generated by the animation data generation method as described in the above first aspect and various possible designs of the first aspect;
a processing module configured to obtain a first image frame and a second image frame based on the animation data, where the first image frame is an animation start frame of the target animation, and the second image frame is a subsequent image frame adjacent to the first image frame; and
a playback module configured to play at least the first image frame and the second image frame in sequence.

According to one or more embodiments of the present disclosure, the animation data further includes restoration information, where the restoration information is used to represent a position of the differential content in the frame difference picture within the second image frame.

According to one or more embodiments of the present disclosure, the animation data includes the first image frame, a first frame difference picture, and a second frame difference picture, where the first frame difference picture represents a color luminance difference of the second image frame relative to the first image frame, and the second frame difference picture represents a transparency difference of the second image frame relative to the first image frame; and the processing module is specifically configured to: obtain the first image frame in the animation data; and generate the second image frame based on the first image frame, the first frame difference picture, and the second frame difference picture.

In a fifth aspect, according to one or more embodiments of the present disclosure, an electronic device is provided, including: a processor and a memory communicatively connected to the processor, where the memory stores computer-executable instructions; and the processor executes the computer-executable instructions stored in the memory to implement the animation data generation method as described in the above first aspect and various possible designs of the first aspect or the animation data playback method as described in the above second aspect and various possible designs of the second aspect.

In a sixth aspect, according to one or more embodiments of the present disclosure, there is provided a computer-readable storage medium storing computer-executable instructions that, when executed by a processor, cause the animation data generation method as described in the above first aspect and various possible designs of the first aspect or the animation data playback method as described in the above second aspect and various possible designs of the second aspect to be implemented.

In a seventh aspect, an embodiment of the present disclosure provides a computer program product including a computer program that, when executed by a processor, causes the animation data generation method as described in the above first aspect and various possible designs of the first aspect or the animation data playback method as described in the above second aspect and various possible designs of the second aspect to be implemented.

In an eighth aspect, according to some embodiments of the present disclosure, there is provided a computer program, including instructions that, when executed by a processor, cause the processor to implement the animation data generation method of any embodiment of the present disclosure.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An animation data generation method, comprising:
obtaining a set of images to be processed, wherein the set of images to be processed comprises at least a first image frame and a second image frame, wherein the first image frame is an animation start frame of a target animation, and the second image frame is a subsequent image frame adjacent to the first image frame;
obtaining a frame difference picture based on the first image frame and the second image frame, wherein the frame difference picture represents a differential content of the second image frame relative to the first image frame; and
generating animation data corresponding to the target animation based on the first image frame and the frame difference picture.

2. The animation data generation method according to claim 1, wherein the animation data comprises a first frame difference picture and a second frame difference picture, wherein the first frame difference picture represents a color luminance difference of the second image frame relative to the first image frame, and the second frame difference picture represents a transparency difference of the second image frame relative to the first image frame.

3. The animation data generation method according to claim 2, wherein the first frame difference picture is in a Joint Photographic Experts Group (JPEG) image format, and the second frame difference picture is in a Portable Network Graphics (PNG) image format.

4. The animation data generation method according to claim 1, wherein the obtaining a frame difference picture based on the first image frame and the second image frame comprises:
dividing the first image frame and the second image frame based on a same specification to obtain a target number of first image blocks corresponding to the first image frame and the target number of second image blocks corresponding to the second image frame;
comparing first image blocks and second image blocks at same image block positions in the first image frame and the second image frame to obtain at least one difference image block, wherein the difference image block is a second image block different from a first image block at a same image block position; and
generating the frame difference picture based on the difference image block.

5. The animation data generation method according to claim 4, wherein the comparing first image blocks and second image blocks at the same image block positions in the first image frame and the second image frame to obtain at least one difference image block comprises:
obtaining, for each image block position of the image block positions, a pixel value of a first pixel in the first image block and a pixel value of a second pixel in the second image block, respectively;
obtaining a grayscale value corresponding to the first pixel based on the pixel value of the first pixel;
obtaining a grayscale value corresponding to the second pixel based on the pixel value of the second pixel; and
obtaining the difference image block based on the grayscale value corresponding to the first pixel in the first image block and the grayscale value corresponding to the second pixel in the second image block.

6. The animation data generation method according to claim 5, wherein the obtaining the difference image block based on the grayscale value corresponding to the first pixel in the first image block and the grayscale value corresponding to the second pixel in the second image block comprises:
obtaining a first average grayscale value corresponding to the first image block based on the grayscale value corresponding to the first pixel in the first image block;
obtaining a second average grayscale value corresponding to the second image block based on the grayscale value corresponding to the second pixel in the second image block; and
obtaining the difference image block based on the first average grayscale value and the second average grayscale value.

7. The animation data generation method according to claim 5, further comprising:
performing low-pass filtering on the grayscale value corresponding to the first pixel in the first image block to obtain a filtered grayscale value corresponding to the first pixel in the first image block; and
performing low-pass filtering on the grayscale value corresponding to the second pixel in the second image block to obtain a filtered grayscale value corresponding to the second pixel in the second image block,
wherein the obtaining the difference image block based on the grayscale value corresponding to the first pixel in the first image block and the grayscale value corresponding to the second pixel in the second image block comprising:
obtaining the difference image block based on the filtered grayscale value corresponding to the first pixel in the first image block and the filtered grayscale value corresponding to the second pixel in the second image block.

8. The animation data generation method according to claim 4, wherein the generating the frame difference picture based on the difference image block comprises:
obtaining an image block coordinate corresponding to the difference image block, wherein the image block coordinate represents a position of the difference image block in the first image frame or the second image frame;
generating a coordinate sequence based on the image block coordinate corresponding to the difference image block; and
arranging and stitching the difference image block based on the generated coordinate sequence to generate the frame difference picture.

9. The animation data generation method according to claim 4, wherein the difference image block comprises a first difference image block and a second difference image block, wherein the first difference image block is an image block having a color luminance difference, and the second difference image block is an image block having a transparency difference, and the comparing first image blocks and second image blocks at same block positions in the first image frame and the second image frame to obtain at least one difference image block comprises:
obtaining a pixel value of a first pixel in the first image block and a pixel value of a second pixel in the second image block, respectively; and
obtaining the first difference image block and the second difference image block based on the pixel value of the first pixel and the pixel value of the second pixel.

10. The animation data generation method according to claim 9, wherein the pixel value comprises three-channel color luminance values and a one-channel transparency value, and the obtaining the first difference image block and the second difference image block based on the pixel value of the first pixel and the pixel value of the second pixel comprises:
obtaining the first difference image block based on color luminance values of the first pixel in the first image block and color luminance values of the corresponding second pixel in the second image block; and
obtaining the second difference image block based on a transparency value of the first pixel in the first image block and a transparency value of the corresponding second pixel in the second image block.

11. The animation data generation method according to claim 1, further comprising:
generating restoration information based on the frame difference picture, wherein the restoration information is configured to represent a position of the differential content in the frame difference picture within the second image frame,
wherein the generating animation data corresponding to the target animation based on the first image frame and the frame difference picture comprises:
generating the animation data corresponding to the target animation based on the first image frame, the frame difference picture, and the restoration information.

12. The animation data generation method according to claim 1, further comprising:
obtaining transparency values corresponding to pixels in the first image frame and the second image frame; and
weighting, based on the transparency values, color luminance values corresponding to the pixels in the first image frame and the second image frame to obtain a first weighted image frame corresponding to the first image frame and a second weighted image frame corresponding to the second image frame,
wherein the obtaining a frame difference picture based on the first image frame and the second image frame comprising:
obtaining the frame difference picture based on the first weighted image frame and the second weighted image frame.

13. An animation data playback method, comprising:
obtaining animation data corresponding to a target animation, wherein the animation data is generated by the animation data generation method according to claim 1;
obtaining a first image frame and a second image frame based on the animation data, wherein the first image frame is an animation start frame of the target animation, and the second image frame is a subsequent image frame adjacent to the first image frame; and
playing at least the first image frame and the second image frame in sequence.

14. The animation data generation method according to claim 13, wherein the animation data comprises the first image frame, a first frame difference picture, and a second frame difference picture, wherein the first frame difference picture represents a color luminance difference of the second image frame relative to the first image frame, and the second frame difference picture represents a transparency difference of the second image frame relative to the first image frame; and
the obtaining a first image frame and a second image frame based on the animation data comprises:
obtaining the first image frame in the animation data; and
generating the second image frame based on the first image frame, the first frame difference picture, and the second frame difference picture.

15-16. (canceled)

17. An electronic device, comprising: a processor and a memory communicatively connected to the processor, wherein
the memory stores computer-executable instructions; and
the processor executes the computer-executable instructions stored in the memory to implement an animation data generation method, comprising:
obtaining a set of images to be processed, wherein the set of images to be processed comprises at least a first image frame and a second image frame, wherein the first image frame is an animation start frame of a target animation, and the second image frame is a subsequent image frame adjacent to the first image frame;
obtaining a frame difference picture based on the first image frame and the second image frame, wherein the frame difference picture represents a differential content of the second image frame relative to the first image frame; and
generating animation data corresponding to the target animation based on the first image frame and the frame difference picture.

18. A non-transitory computer-readable storage medium storing computer-executable instructions that, when executed by a processor, cause an animation data generation method to be implemented, wherein the animation data generation method comprises:
obtaining a set of images to be processed, wherein the set of images to be processed comprises at least a first image frame and a second image frame, wherein the first image frame is an animation start frame of a target animation, and the second image frame is a subsequent image frame adjacent to the first image frame;
obtaining a frame difference picture based on the first image frame and the second image frame, wherein the frame difference picture represents a differential content of the second image frame relative to the first image frame; and
generating animation data corresponding to the target animation based on the first image frame and the frame difference picture.

19-20. (canceled)

21. The electronic device according to claim 17, wherein the animation data comprises a first frame difference picture and a second frame difference picture, wherein the first frame difference picture represents a color luminance difference of the second image frame relative to the first image frame, and the second frame difference picture represents a transparency difference of the second image frame relative to the first image frame.

22. The electronic device according to claim 21, wherein the first frame difference picture is in a Joint Photographic Experts Group (JPEG) image format, and the second frame difference picture is in a Portable Network Graphics (PNG) image format.

23. The non-transitory computer-readable storage medium according to claim 18, wherein the animation data comprises a first frame difference picture and a second frame difference picture, wherein the first frame difference picture represents a color luminance difference of the second image frame relative to the first image frame, and the second frame difference picture represents a transparency difference of the second image frame relative to the first image frame.

24. The non-transitory computer-readable storage medium according to claim 23, wherein the first frame difference picture is in a Joint Photographic Experts Group (JPEG) image format, and the second frame difference picture is in a Portable Network Graphics (PNG) image format.
